(19) United States
(12) Patent Application Publication
(10) Pub. No.: US 2003/0096094 A1
(43) Pub. Date: May 22, 2003

(54) Wood composite material

(76) Inventor: John A. Hayduke, Coloma, MI (US)

Correspondence Address: REISING, ETHINGTON, BARNES, KISSELLE,, LEARMAN & McCULLOCH, P.C., P.O. Box 4390, Troy, MI, 48099-4390, US

(21) Appl. No.: 09/992,196

(22) Filed: Nov. 19, 2001

(51) Int. Cl. B32B 21/02

(52) U.S. Cl. 428/292.4

(57) ABSTRACT

A composite material including a substrate material having an ABS terpolymer resin and a cellulosic material. The ABS terpolymer resin is present in an amount of from 20 to 75 weight percent based on the total weight of the substrate material. The cellulosic material is present in an amount of from 25 to 75 weight percent based on the total weight of the substrate material. The composite material also includes a capstock material of a weather-resistant thermoplastic. The capstock material is compatible with the substrate material such that additional adhesives are not required to bond the substrate material with the capstock material in a coextrusion process.

### BACKGROUND OF THE INVENTION

1. Field of the Invention

The present invention relates to a composite material having a substrate and a capstock material. With more particularity, the present invention relates to a composite material having a substrate including an ABS polymer resin and a cellulosic material and a capstock material bonded to the substrate.

2. Description of The Related Art

Wood products are commonly used in the construction industry as structural support members, as well as for aesthetic purposes. The amount of mature trees available for use as wood products is shrinking in relation to the demand for such products. Therefore, there is an economic and an environmental incentive for utilizing composite materials in the construction industry.

Wood replacement materials or composites are known in the art and generally utilize wood scraps such as sawdust or other cellulosic materials in combination with a plastic resin to form a composite material. Known composite materials include various cellulosic materials combined with plastic resins including polyethylene, and vinyl chloride polymer.

The known composite materials have limitations as to the processing and appearance. For example, a composite material made of a vinyl chloride polymer combined with wood flour may exhibit poor surface characteristics leading to an undesirable appearance. Such vinyl based composite materials, may also exhibit increased processing problems in comparison to other thermoplastic resins.

Composite materials utilized in the construction industry should have high strength characteristics, as well as, improved weatherability in comparison to wood-based products.

There is, therefore, a need in the art, for a composite material that is easy to process, exhibits increased strength and improved surface characteristics, as well as demonstrates an increased resistance to the elements.

### SUMMARY OF THE INVENTION

A composite material including a substrate having an acrylonitrile-butadiene-styrene (ABS) terpolymer present in an amount of from 20 to 75 weight percent based on the total weight of the substrate material. The substrate also includes a cellulosic material present in an amount of from 25 to 75 percent by weight based on the total weight of the substrate material. There is also included a capstock material which is a weather-resistant thermoplastic that is compatible with the substrate material, such that additional adhesives are not required to bond the substrate with the capstock material.

The composite material of the present invention has the advantage of providing an ABS substrate material that is capable of handling high loads of cellulosic material and exhibits increased strength and processing characteristics.

The composite material of the present invention also provides the advantage of including a capstock material of a weather-resistant thermoplastic that is coextruded with the substrate material to produce a composite material that does not require additional adhesives to bond the substrate with the capstock material.

### DETAILED DESCRIPTION OF THE INVENTION

The present invention is a composite material having a substrate of an ABS terpolymer resin combined with a cellulosic material. There is also included a capstock material of a weather-resistant thermoplastic material that is compatible with the substrate material such that additional adhesives are not required to bond the substrate with the capstock material.

The substrate material includes an ABS terpolymer resin present in an amount of from 20 to 75 weight percent based on the total weight of the substrate material. The ABS terpolymer resin may be combined with a copolymer such as, for example, polyvinylchloride (PVC) or other polyolefins that are compatible with ABS. The co-polymer may be present in an amount of from zero to less than 15 percent by weight based on the total weight of the substrate material.

The substrate material of the present invention also includes cellulosic material in an amount of from 25 to 75 weight percent based on the total weight of the substrate material. Even more preferably, the cellulosic material may be present in an amount of from 35 to about 45 percent by weight of the substrate material. The cellulosic material may be selected from the group consisting of wood sawdust, seed husks, rice hulls, newspaper, kenaf, coconut shells, bagasse, corn cobs, peanut shells, paper pulp and mixtures of the above. [0013] The cellulosic material has a moisture content of from 0.3 to about 2 percent, preferably with a moisture content less than 1 percent by weight. At moisture contents exceeding 2 percent, the composite material of the present invention may exhibit defects such as pitting and surface scarring when processed due to the formation of water vapor.

The substrate material may farther include a polar thermosetting material for adding to the strength and processability of the substrate material. The polar thermosetting material is present in an amount of from zero to less than 15 percent by weight based on the total weight of the substrate material. The polar thermosetting material may be selected from the group consisting of polyurethanes, polyethylenes and polystyrenes.

The composite material of the present invention further includes a capstock material of a weather-resistant thermoplastic resin. The capstock material is compatible with the substrate material such that additional adhesives are not required to bond the substrate with the capstock material in a coextrusion operation. Examples of suitable weather-resistant thermoplastic materials include polymers of vinyl chloride including polyvinyl chloride (PVC). The PVC capstock material exhibits excellent adhesion to the ABS terpolymer resin substrate material, such that additional adhesives are not required to bond the substrate with the capstock material.

The composite material of the present invention may further include additional components such as: additives, stabilizers, plasticizers, UV additives, lubricants, and compatibilizers. Specifically, heat stabilizers such as tin, lead, barium, cadmium, and zinc may be utilized by the present invention to prevent thermal degradation of the ABS terpolymer during processing.

Internal and external lubricants utilized in the plastics industry may be used to aid in the processing of the composite material. Examples of lubricants include: calcium stearate, esters, paraffin wax, and amide wax. Additional components such as plasticizers that may aid in the processing of the ABS terpolymer as well as UV additives to prevent the breakdown of the capstock material when exposed to sunlight, may be utilized by the present invention. Additionally, foaming agents and compatibilizers may also be utilized by the present invention.

The composite material of the present invention may be manufactured utilizing a coextrusion process directly following a mixing and compounding of the substrate material, or the substrate material may be pelletized and later utilized in a coextrusion process to produce the composite material. The coextrusion process generally utilizes two extruders commonly attached to a single die, although other known arrangements may be utilized by the present invention.

### EXAMPLES

The composite material of the present invention was manufactured by combining an ABS terpolymer resin with a PVC copolymer resin including stabilizers, lubricants, impact modifiers, and processing aids. The resins were mixed in a mixer and then introduced into the feed throat of a co-rotating twin screw extruder. Wood flour that was dried to a moisture content of less than 0.5 weight percent and injected into the ABS resin by means of a side feeder attached to the extruder. The polymer blend and the wood flour were then blended in the extruder prior to reaching a venting section in the extruder. A vacuum was applied in the venting section to reduce any gassing in the extrudate. A 72-hole strand die was attached to the extruder to produce a pelletized extrudate. The pellets were then dried in a hot air dryer for approximately one hour to further reduce the moisture content of the pellets.

The pellets were then later processed in a coextrusion operation in which the substrate was coextruded with a PVC capstock material. The pellets were introduced into a dessicant dryer attached to the feed throat of a single screw extruder. The moisture content of the pellets fed through the extruder was approximately 0.2 percent by weight. The pellets were then processed through the single extruder at a process temperature of approximately 350° F. A hollow profile die was attached to the extruder to produce a 4×4 post, commonly used in the construction industry. A coextruder was also attached to the hollow profile die to place a PVC capstock on the substrate material. The PVC capstock material was bonded to the ABS substrate material without the use of additional adhesives.

The present invention has been described in accordance with the relevant legal standards, thus the foregoing description is exemplary rather than limiting in nature. Various modifications to the disclosed embodiment may become apparent to those skilled in the art. Accordingly, the scope of legal protection afforded this invention can be determined by studying the following claims.

What is claimed is:

1. A composite material comprising:
a) a substrate material comprising:
1) an ABS terpolymer resin present in an amount of from 20 to 75 weight percent based on the total weight of the substrate material;
2) cellulosic material present in an amount of from 25 to 75 weight percent based on the total weight of the substrate material;
b) a capstock material comprising, a weather resistant thermoplastic material, the capstock material being compatible with the substrate material such that additional adhesives are not required to bond the substrate with the capstock.

2. The composite material of claim 1 wherein the substrate material further includes a polar thermosetting material.

3. The composite material of claim 2 wherein the polar thermosetting material is present in an amount of less than 15 weight percent based on the total weight of the substrate material.

4. The composite material of claim 2 wherein the polar thermosetting material is selected from the group consisting of: polyurethanes, polyethylenes, and polystyrenes.

5. The composite material of claim 1 wherein the cellulosic material is present in an amount of from 35 to 45 weight percent based on the total weight of the substrate material.

6. The composite material of claim 1 wherein the cellulosic material is selected from the group consisting of: wood sawdust, seed husks, rice hulls, newspaper, kenaf, coconut shells, bagasse, corn cobs, peanut shells, paper pulp and mixtures thereof.

7. The composite material of claim 1 wherein the substrate material further includes PVC.

8. The composite material of claim 7 wherein the PVC is present in an amount of less than 15 percent by weight based on the total weight of the substrate material.

9. The composite material of claim 1 wherein the capstock material is coextruded with the substrate material to form the composite material.

10. The composite material of claim 9 wherein the capstock material comprises PVC.

11. The composite material of claim 1 wherein the moisture content of the substrate material at a time of mixing and compounding is less than one percent.

12. The composite material of claim 1 wherein the substrate material is bonded with the capstock material in a coextrusion process directly following a mixing and compounding step of the substrate material.

13. The composite material of claim 1 wherein the substrate material is processed to form a pellet that is then further utilized in a coextrusion process wherein the capstock material is bonded with the substrate material.

14. The composite material of claim 13 wherein the pellet has a moisture content of less than 0.3 percent when utilized in the coextrusion process.

15. The composite material of claim 1 wherein the composite material further includes additives, stabilizers, plasticizers, TV additives, lubricants, and compatibilizers.

16. A composite material comprising:
a) a substrate material comprising:
1) an ABS terpolymer resin present in an amount of from 20 to 75 weight percent based on the total weight of the substrate material;
2) cellulosic material present in an amount of from 25 to 75 weight percent based on the total weight of the substrate material;
3) a polar thermosetting material present in an amount of from 0.1 to 15 weight percent based on the total weight of the substrate material;
b) a capstock material comprising, a weather resistant thermoplastic material; the capstock material being compatible with the substrate material such that additional adhesives are not required to bond the substrate with the capstock.

17. The composite material of claim 16 wherein the polar thermosetting material is selected from the group consisting of: polyurethanes, polyethylenes, and polystyrenes.

18. The composite material of claim 16 wherein the cellulosic material is present in an amount of from 35 to 45 weight percent based on the total weight of the substrate material.

19. The composite material of claim 16 wherein the cellulosic material is selected from the group consisting of: wood sawdust, seed husks, rice hulls, newspaper, kenaf, coconut shells, bagasse, corn cobs, peanut shells, paper pulp and mixtures thereof.

20. The composite material of claim 16 wherein the substrate material further includes PVC.

21. The composite material of claim 20 wherein the PVC is present in an amount of less than 15 percent by weight based on the total weight of the substrate material.

22. The composite material of claim 16 wherein the capstock material is coextruded with the substrate material to form the composite material.

23. The composite material of claim 22 wherein the capstock material comprises PVC.

24. The composite material of claim 16 wherein the moisture content of the substrate material at a time of mixing and compounding is less than one percent.

25. The composite material of claim 16 wherein the substrate material is bonded with the capstock material in a coextrusion process directly following a mixing and compounding step of the substrate material.

26. The composite material of claim 16 wherein the substrate material is processed to form a pellet that is then further utilized in a coextrusion process wherein the capstock material is bonded with the substrate material.

27. The composite material of claim 26 wherein the pellet has a moisture content of less than 0.3 percent when utilized in the coextrusion process.

28. The composite material of claim 16 wherein the composite material further includes additives, stabilizers, plasticizers, WV additives, lubricants, and compatibilizers.

29. An extruded article produced by coextruding a composite material, the composite material comprising:
a) a substrate material comprising:
1) an ABS terpolymer resin present in an amount of from 20 to 75 weight percent based on the total weight of the substrate material;
2) cellulosic material present in an amount of from 25 to 75 weight percent based on the total weight of the substrate material;
b) a capstock material comprising, a weather resistant thermoplastic material; the capstock material being compatible with the substrate material such that additional adhesives are not required to bond the substrate with the capstock in the coextrusion process.
